(19) United States
(12) Patent Application Publication
(10) Pub. No.: US 2007/0133219 A1
(43) Pub. Date: Jun. 14, 2007

(54) Vehicle interior light assembly with removable flashlight

(76) Inventors: Brian Chaloult, Rochester Hills, MI (US); Blair S. Parker, Oak Park, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/301,955

(22) Filed: Dec. 13, 2005

(51) Int. Cl. B60Q 3/02; F21L 4/08

(52) U.S. Cl. 362/490; 362/488; 362/486; 362/200; 362/183

(57) ABSTRACT

A vehicle interior light assembly having a conventional interior light such as a dome, courtesy or map light, as well as a detachable and rechargeable flashlight all in an integrated assembly. The vehicle interior light assembly preferably includes a plastic housing unit with first and second elongated cavities, a stationary illumination device located in the first cavity, a removable illumination device or flashlight detachably installed in the second cavity, and electrical connections for connecting the assembly to a vehicle electrical system. The stationary illumination device operates as a standard vehicle interior light, while the flashlight can be operated according to one of at least two separate lighting modes, where one of the lighting modes uses less energy than the other.

### FIELD OF THE INVENTION

The present invention relates generally to electrical assemblies for installation in a vehicle interior, and more particularly, to electrical assemblies that have a removable component for portable use, such as a flashlight.

### BACKGROUND OF THE INVENTION

It is generally known in the art to combine a vehicle interior light with a removable and rechargeable flashlight, however, there is still much room for improvement. For instance, in view of all of the multimedia and other electronic components now being offered in vehicle interiors, it is desirable to provide compact interior components that take up as little space as possible and are energy efficient. Designing aesthetically pleasing and easy-to-use interior vehicle components that satisfy the above-mentioned design goals can be challenging, as demonstrated by the myriad of interior component designs present in the market place.

### SUMMARY OF THE INVENTION

According to one aspect of the present invention, there is provided a vehicle interior light assembly having a housing unit, electrical connections, a stationary illumination device and a removable illumination device. The housing unit includes a back side and a front side with first and second cavities generally separated by a divider and surrounded by a bezel. The first and second cavities and the divider generally extend lengthwise of the housing unit. The stationary illumination device is located within the first cavity and is coupled to the electrical connections, while the removable illumination device is detachably located within the second cavity for recharging.

According to another aspect of the invention, there is provided a vehicle interior module having a housing unit, a first set of electrical connections and a removable and rechargeable flashlight. The flashlight is detachably installed in the housing unit and includes first and second housing components that securely retain a battery, a second set of electrical connections, a button, a circuit board and at least one light emitting element. The button enables the flashlight to be operated according to at least first and second lighting modes, where the second lighting mode uses less energy than the first lighting mode.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an interior view of an example of a vehicle front seat area having several vehicle interior light assemblies mounted at different locations;

FIG. 2 is a front side perspective view of an embodiment of one of the vehicle interior light assemblies of FIG. 1 and shows a removable flashlight being detached from the rest of the assembly;

FIG. 3 is a back side perspective view of the vehicle interior light assembly of FIG. 2;

FIG. 4 is an exploded perspective view of the removable flashlight of FIG. 2; and

FIG. 5 is a perspective view of the removable flashlight of FIG. 2.

### DETAILED DESCRIPTION OF THE PREFERRED EMBODIMENTS

The following description of the preferred embodiments is merely exemplary in nature and is in no way intended to limit the invention, its application, or uses.

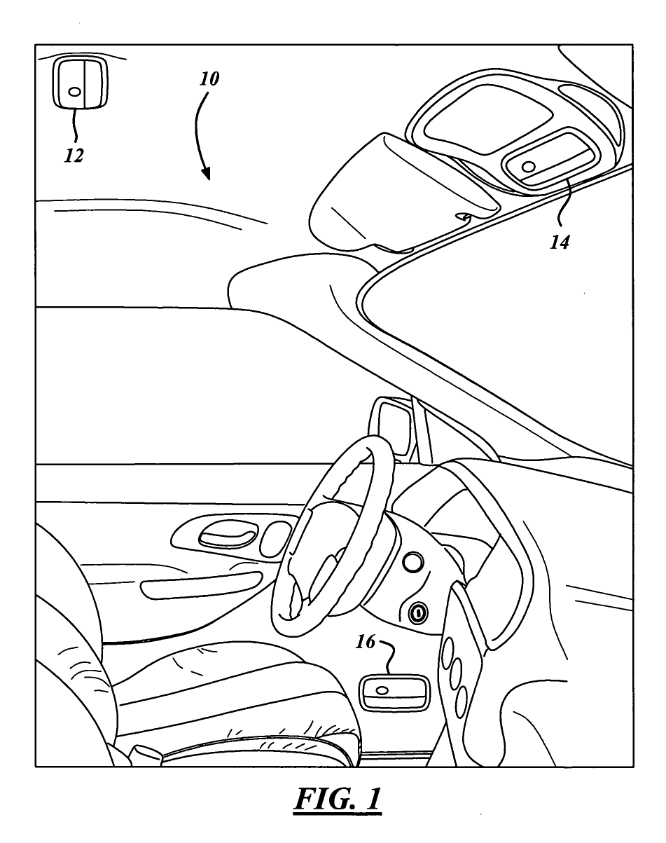

With reference to FIG. 1, there is shown an example of a vehicle interior 10 in which several vehicle interior light assemblies each having a removable flashlight are installed. According to this particular embodiment, interior 10 includes a first vehicle interior light assembly 12 that is located in a ceiling panel and is used as a dome light, a second vehicle interior light assembly 14 that is integrated within a ceiling-mounted console and functions as a map light, and a third vehicle interior light assembly 16 which is positioned near the bottom of an interior door panel and acts as a courtesy light. These are, of course, only examples of some of the suitable applications in which the vehicle interior light assembly may be used, as that assembly is not limited to the specific exemplary embodiments shown here. Furthermore, as evidenced by the dome and map light examples above, the vehicle interior light assembly can be a stand alone electrical component or it can be integrated within a larger electrical module such as the ceiling-mounted console.

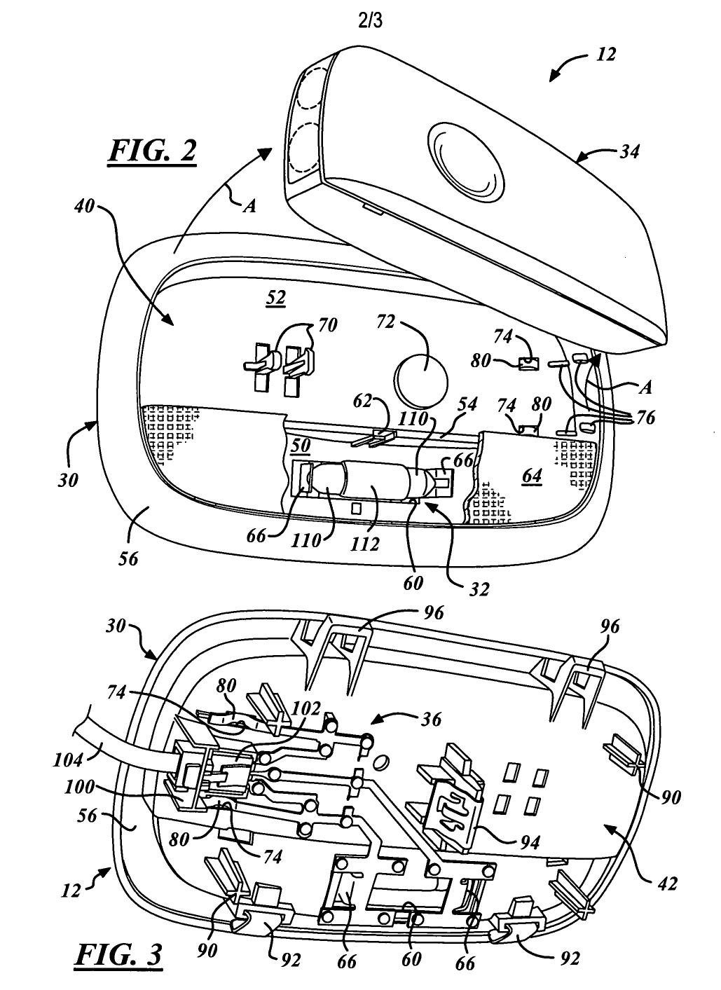

Turning now to FIGS. 2 and 3, there is shown a more detailed embodiment of vehicle interior light assembly 12 that generally includes a housing unit 30, a stationary illumination device 32 for providing illumination to the surrounding vehicle interior, a removable illumination device or flashlight 34 for portable use, and electrical connections 36 for connecting the assembly to a vehicle electrical system. As will be explained in greater detail, vehicle interior light assembly 12 provides a user with both a conventional vehicle interior light (stationary illumination device 32) as well as a detachable and rechargeable flashlight (removable illumination device 34) all in an integrated assembly that is easy to manufacture, install and operate.

Housing unit 30 is preferably a rectangular-shaped plastic component that generally includes a front side 40 (FIG. 2) for facing a vehicle cabin interior and a back side 42 (FIG. 3) for facing a vehicle interior component such as a ceiling or door panel. Front side 40 of the housing unit preferably includes first and second cavities 50 and 52 (cavity 50 is partially obstructed by a lens 64), a divider 54 and a peripheral bezel 56. The first and second cavities 50, 52 are designed to receive stationary and removable illumination devices 32, 34, respectively, and generally extend lengthwise of housing unit 30 such that they are separated from one another by divider 54 and are encircled by bezel 56.

First cavity 50 is preferably rectangular in shape such that it is bounded by bezel 56 on three sides and divider 54 on one side, and generally includes an opening 60 and one or more attachment features 62. It is, of course, possible to provide first cavity 50 in a non-rectangular or elongated form other than that shown here. Opening 60 is formed in a back wall of cavity 50 and provides access for metal terminals 66, which are part of electrical connections 36 and protrude through housing unit 30 in order to retain stationary illumination device 32 in place and provide it with electrical connectivity. Attachment features 62 are notched-out channels located at one or more positions around the periphery of first cavity 50 and are designed to receive complementary tabs or barbs (not shown) that extend downwards from a translucent lens 64 so that the lens can be snapped into place. Translucent lens 64 is preferably stippled on its underside so that light emitted from stationary illumination device 32 is transmitted through the lens but is somewhat diffused.

Second cavity 52 is somewhat larger than first cavity 50 and is designed to detachably receive flashlight 34, which has a complementary exterior shape. The second cavity preferably includes mounting features 70 located near the middle of the cavity, a compressible pad 72 positioned nearby, a pair of openings 74, and several ears 76 extending inwardly into the cavity. Mounting features 70 work in conjunction with ears 76 to detachably engage corresponding recesses located on the underside of flashlight 34 so that the flashlight can be easily removed from or installed into second cavity 52 according to the release arrows A shown in FIG. 2. According to this particular embodiment, mounting features 70 include a pair of posts with enlarged ends and are referred to as a two-position release mechanism. Of course, other appropriate types of mounting features known in the art could also be used, as the two-position type shown here is simply one example. Compressible pad 72 provides some cushion between the back wall of second cavity 52 and an underside of flashlight 34 so that there is no play between the two components when the flashlight is installed within the second cavity. Openings 74 are preferably small, elongated slots formed in the back wall of second cavity 52 and allow electrical contacts 80, which are part of electrical connections 36, to protrude through such that they contact corresponding terminals located on the underside of flashlight 34. Contacts 80 recharge the flashlight when it is installed within second cavity 52, as will be subsequently explained in greater detail.

Divider 54 is preferably a thin upright-standing, integrally-formed plastic wall that generally extends lengthwise of housing unit 30 so that it separates first and second cavities 50, 52 from one another. According to the embodiment shown here, divider 54 generally extends to near the top of first and second cavities 50, 52 so that when lens 64 is snapped into place over top of first cavity 50, it rests on an upper edge of divider 54 and a peripheral shoulder of bezel 56. Divider 54 could alternatively be designed with one or more features such as an opening allowing access between the first and second cavities, a reflective component for improving the illuminance of device 32, strengthening ribs, additional attachment features like feature 62, etc.

Bezel 56 extends around the outer periphery of housing unit 30 and is stepped (best seen in FIG. 3) so that when it is installed in an opening formed in a vehicle interior component such as a ceiling or door panel, there are no visible gaps between the opening and the housing unit. Preferably, bezel 56 is integrally formed with the rest of housing unit 30, however, it could be provided as a separate component that attaches to the housing unit via one or more attachment features. Furthermore, it is possible to include indicia on one or more sides of bezel 56 that indicates different features of the assembly; for instance, the word “FLASHLIGHT” could be added to bezel 56 at a position adjacent to second cavity 52 so that a user would know that there is a detachable flashlight located therein.

The backside 42 of housing unit 30 is designed to face a vehicle interior component and therefore includes a number of commonly known installation features such as locator prongs 90, headliner clips 92, sheet metal clip 94 and engagement tabs 96, to name but a few, as well as a female plug 100. The female plug receives a male plug 102 of a multi-connection wiring harness 104, which is in turn coupled to the vehicle electrical system. Because numerous types of housing unit backsides are known in the art and because the particular design and embodiment of the backside is not critical, a further explanation of backside 42 has been omitted.

Stationary illumination device 32 can include one or more of any number of different types of light sources, but is preferably an elongated 12 volt, 5 watt incandescent bulb. The stationary illumination device shown here generally includes metal terminals 110 located on each end of an elongated glass envelope 112. As is well known in the art, metal terminals 66 are spring biased towards one another such that illumination device 32 is resiliently retained in between them, thus providing secure mechanical retention of the light source and providing it with good electrical contacts.

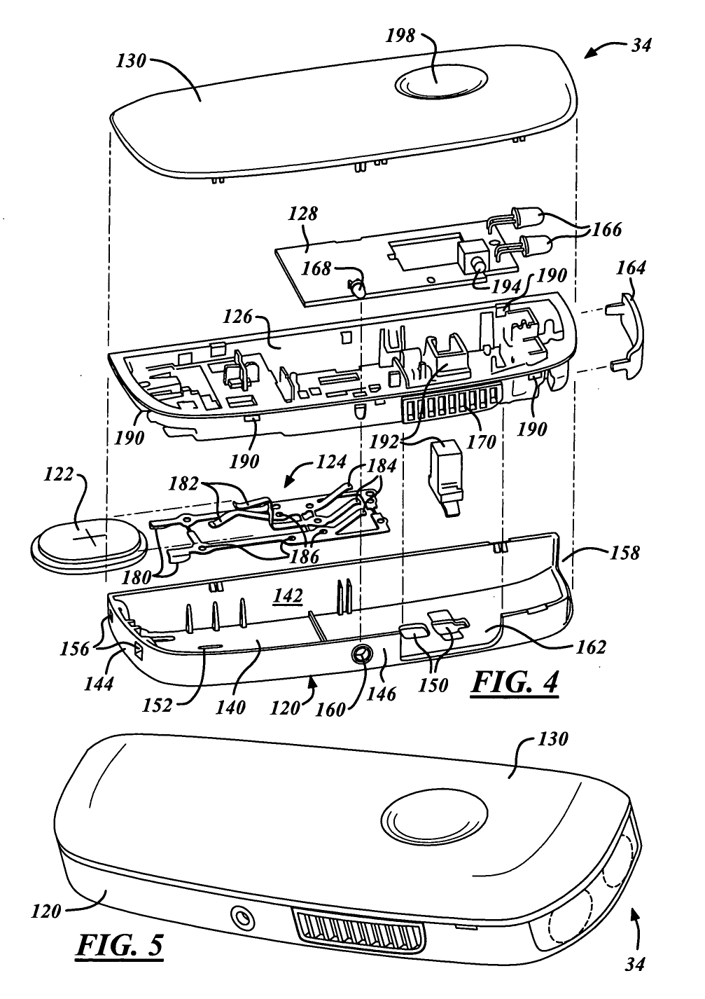

With reference now to FIGS. 4 and 5, there is respectively shown exploded and assembled views of removable illumination device or flashlight 34 which generally includes a lower housing component 120, an energy storage device 122, electrical connections 124, interior housing component 126, electronic circuit board 128 and upper housing component 130. The lower and upper housing components 120 and 130 are preferably made of a rigid plastic material, perhaps the same material used to make housing unit 30, and are designed to snap fit together such that internal components 122-128 are compactly and securely retained between them.

Lower housing component 120 preferably provides a recessed or hollowed-out space for the rest of the components of flashlight 34 to reside, and generally includes a flat surface 140 having three upright-standing walls 142-146 integrally formed therewith. Flat surface 140 forms the bottom of flashlight 34 and includes two pairs of openings; a first pair of generally square-shaped openings 150 interacts with protruding mounting features 70 so that the flashlight may be released from the cavity according to the two-position release mechanism previously mentioned, and a second pair of slot-shaped openings 152 which provide access for metal contacts that extend from electrical connections 124. Of course, the lower housing components could also include other features such as strengthening ribs, dividers, locator pins, etc. Wall 142 is preferably flat and is designed to abut divider 54 when the flashlight is installed in second cavity 52. Wall 144 preferably forms a squared-off corner with adjacent wall 142, but curves into wall 146 such that a rounded corner is formed. Wall 144 includes a pair of recessed openings 156 that mechanically interact with ears 76 in order to aid in the smooth installation and release of flashlight 34. As just mentioned, wall 146 shares a rounded corner or junction with wall 144 and according to a preferred embodiment abruptly terminates at its opposite end. The reason for the sudden termination is a large opening 158 in the front end of the flashlight 34, which is designed to accommodate a flashlight lens 164 so that light emitted from a pair of light emitting diodes (LEDs) 166 can exit the housing and provide illumination. Wall 146 also includes a small circular opening 160 for accommodating an LED indicator 168, and a larger opening 162 for providing access to button 170 which controls the operation of the flashlight.

Energy storage device or battery 122 is preferably a small, oval-shaped rechargeable Nickel-Metal Hydride (NiMH) battery having a positive terminal on one side (shown in FIG. 4) and a negative terminal (not shown) on the other side. The battery is designed to fit between and interact with resilient metal contacts 182 which are a part of electrical connections 124. Although other types of suitable non-NiMH batteries can also be used, NiMH batteries can stored up to 50% more power than comparable Nickel Cadmium (NiCd) batteries and do not suffer from certain memory effects.

Electrical connections 124 are preferably stamped from a sheet of an appropriate conductive material such as copper (Cu) or a Cu-alloy known to those skilled in the art, and provide the electrical connectivity needed for operation of flashlight 34. Electrical connections 124 contain a number of different paths, traces, contacts, etc. and conductively connect the electrical connections 36 of the assembly to battery 122, and connect the battery to circuit board 128. According to the embodiment shown here, electrical connections 124 include a pair of fin-like contacts 180 that extend through slots 152, a pair of resilient arms 182 that contact the positive and negative terminals of battery 122, contacts 184 that provide circuit board 128 with power and ground signals, and a number of holes 186 that receive plastic attachment pins protruding from interior housing component 126. During manufacture, electrical connections 124 are placed on the interior housing component so that the attachment pins line up with and extend through holes 186, after which the ends of the pins are heated and deformed so that the electrical connections are firmly attached to the interior housing component 126.

Interior housing component 126 snap-fits within lower housing component 120 and is designed to maintain all of the interior flashlight components in their appropriate locations. The interior housing component preferably includes button 170 which was previously-mentioned, a series of attachment features 190 for attachment of component 126 to the upper and/or lower housing features 120, 130, and release mechanism 192 which interacts with mounting features 70 through access opening 150. Although button 170 can be any suitable switch, knob or other type of electronic control, it is preferably an elongated, depressible button having a number of short ridges for improved grip. Button 170 is operably coupled to an activation switch 194 which in turn is electrically connected to circuit board 128. As previously stated, the protruding male-like mounting features 70 of second cavity 52 releaseably interact with the female-like release mechanism 192 of interior housing component 126 in order to allow two-step detachment of flashlight 34. It is, of course, possible to locate the female features on housing unit 30 instead of on flashlight 34 and to locate the male features on the flashlight instead of on the housing unit, or to provide any other detachable mounting feature arrangement known to those skilled in the art.

Circuit board 128 is preferably a two-sided printed circuit board (PCB) that includes electronic circuitry for controlling operation of flashlight 34 and is connected with LED indicator 168, activation switch 194, and a pair of light emitting elements 166. LED indicator 168 is preferably a small diameter (3 mm or so) red LED that lights up when a lower power condition is sensed on battery 122, thus informing the user that flashlight 34 needs to be recharged. As previously mentioned, activation switch 194 is operably coupled to button 170 so that depression of the button causes the activation switch to send a corresponding signal to the circuit board. Light emitting elements 166 are preferably a pair of side-by-side LEDs (5 mm or so in diameter) and emit a fairly focused, bright white light. Of course, other sources of illumination such as incandescent bulbs, etc. may be used in place of the exemplary LEDs 166.

Upper housing component 130 is preferably a flat, elongated plastic housing component that is designed to snap onto lower housing component 120 such that both housing components encapsulate and protect interior flashlight components 122-128. A depression area 198 is located over top of release mechanism 192 so that when flashlight 34 is installed in second cavity 52, application of pressure on the depression area causes features 70 and 192 to release the flashlight for portable use. As mentioned before, one of a number of different types of release mechanisms may be used in place of the exemplary two-step release mechanism shown and taught herein.

During flashlight charging, the flashlight 34 is installed in second cavity 52 of the housing unit so that the fin-like contacts 180 of the flashlight touch contacts 80 of the housing unit and charge battery 122. Preferably, the battery is charged with 150 mA of charging current and takes about three hours to completely charge. Although not necessary, flashlight 34 is preferably designed so that it cannot be operated when installed in second cavity 52; if it is ‘on’ when installed within housing unit 30, then it is turned ‘off.’ Therefore, in order to operate flashlight 34 it must be removed from housing unit 30. The vehicle interior light assembly 12 may be designed so that removable flashlight 34 charges whenever it is installed within second cavity 52 (flashlight 34 charges independent of operation of stationary illumination device 32), or it can be designed to only charge at certain times, such as when the vehicle door is open and stationary illumination device 32 is on.

During flashlight operation, battery 122 provides the pair of illuminating LEDs 166 with power so that they emit a white light according to one of two or more different lighting modes. Activating button 170 a first time causes LEDs 166 to operate according to a first lighting mode of 100% brightness. If the button is depressed again within a certain amount of time from the first depression (for example, two seconds), then LEDs 166 are operated according to a second, lower power consumption mode of only 50% brightness. Subsequent activation of button 170 within the prescribed time limit causes the flashlight to sequence between the different lighting modes; thus, rapid activation of button 170 simply causes the flashlight to transition between the various lighting modes. If more than two seconds passes before the button is pressed again, it will turn the flashlight off. Other power reductions features can also be incorporated into the functionality of circuit board 128. For instance, if a user does not turn off flashlight 34 after a certain amount of time (for example, seven and one-half minutes) it will automatically turn itself off, or if the charge on the battery is low then the flashlight will automatically be operated in the second, lower power consumption lighting mode. In order to alert the user of a low battery condition, LED indicator 168 emits a warning light when battery 122 is below a certain charge level, and/or LEDs 166 will flash twice. When totally recharged, flashlight 34 should provide about one hour of continuous operation.

According to an alternative embodiment, the removable illumination device or flashlight shown herein could be incorporated within a vehicle interior module lacking an additional stationary illumination device. In such an embodiment, the vehicle interior module would provide mechanical retention of the flashlight and would also recharge it when it was installed and not being used, but would not include a separate dome, map or courtesy light. In an exemplary application for such an embodiment, the vehicle interior module could be incorporated into a ceiling-mounted console having other features such as a multi-media system, etc.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle interior light assembly, comprising:
a housing unit having a back side for attachment to a vehicle interior component, and a front side with first and second cavities generally separated by a divider and surrounded by a bezel, said first and second cavities and said divider generally extend lengthwise of said housing unit;
electrical connections for connection with a vehicle electrical system;
a stationary illumination device located within said first cavity and being coupled to said electrical connections; and
a removable illumination device detachably located within said second cavity, wherein installation of said removable illumination device in said second cavity enables said electrical connections to charge said removable illumination device.

2. The vehicle interior light assembly of claim 1, wherein said housing unit is generally rectangular-shaped and said first and second cavities are elongated so that they extend nearly the entire length of said housing unit.

3. The vehicle interior light assembly of claim 1, wherein said second cavity includes protruding mounting features that form a two-position release mechanism for detachably receiving said removable illumination device.

4. The vehicle interior light assembly of claim 1, wherein said removable illumination device has an exterior shape that is complementary to said second cavity so that said device may be compactly installed within said cavity.

5. The vehicle interior light assembly of claim 1, wherein said removable illumination device includes first and second housing components for securely retaining an energy storage device, electrical connections, a button, a circuit board and at least one lighting emitting element.

6. The vehicle interior light assembly of claim 5, wherein said energy storage device is a rechargeable Nickel-Metal Hydride (NiMH) battery.

7. The vehicle interior light assembly of claim 5, wherein said button is located on a side of said removable illumination device and allows a user to control the operation of said device.

8. The vehicle interior light assembly of claim 5, wherein said circuit board is coupled to an LED indicator that warns a user of a low power condition.

9. The vehicle interior light assembly of claim 5, wherein said at least one light emitting element includes a pair of white, light emitting diodes (LEDs).

10. The vehicle interior light assembly of claim 1, wherein installation of said removable illumination device in said second cavity causes said device to be charged independently of said stationary illumination device.

11. The vehicle interior light assembly of claim 1, wherein installation of said removable illumination device in said second cavity causes said device to be automatically turned off.

12. The vehicle interior light assembly of claim 1, wherein said removable illumination device operates according to at least first and second lighting modes, where said second lighting mode uses less energy than said first lighting mode.

13. The vehicle interior light assembly of claim 12, wherein if said removable illumination device is operating according to said first lighting mode and a charge stored on said device falls below a predetermined level, then said removable illumination device is automatically operated according to said second lighting mode.

14. The vehicle interior light assembly of claim 1, wherein said assembly is integrated within a vehicle ceiling-mounted console.

15. A vehicle interior module, comprising:
a housing unit for attachment to a vehicle interior component;
a first set of electrical connections for connection with a vehicle electrical system;
a removable and rechargeable flashlight detachably installed in said housing unit and including first and second housing components for securely retaining a battery, a second set of electrical connections, a button, a circuit board and at least one light emitting element;
wherein said button is operably coupled to said circuit board and enables said flashlight to operate according to at least first and second lighting modes, where said second lighting mode uses less energy than said first lighting mode.

16. The vehicle interior module of claim 15, wherein said housing unit includes a front side with first and second elongated cavities that are generally separated by a divider and surrounded by a bezel, said first cavity receives a stationary illumination device and said second cavity receives said flashlight.

17. The vehicle interior module of claim 15, wherein said housing unit includes protruding mounting features that form a two-position release mechanism for detachably receiving said flashlight.

18. The vehicle interior module of claim 15, wherein installation of said flashlight in said second cavity causes said flashlight to be automatically turned off.

19. The vehicle interior module claim 15, wherein if said flashlight is operating according to said first lighting mode and a charge stored on said battery falls below a predetermined level, then said flashlight is automatically operated according to said second lighting mode.
